(19) United States
(12) Patent Application Publication
(10) Pub. No.: US 2011/0041060 A1
(43) Pub. Date: Feb. 17, 2011

(54) Video/Music User Interface

(75) Inventors: Windy CHIEN, San Francisco, CA (US); Robert Henry Kondrk, Los Angeles, CA (US); Gary Stewart, Santa Monica, CA (US); Jeff F. Southard, San Francisco, CA (US)

Correspondence Address: Morgan Lewis & Bockius LLP/ AI, 2 Palo Alto Square, 3000 El Camino Real, Suite 700, Palo Alto, CA, 94306, US

(73) Assignee: Apple Inc., Cupertino, CA (US)

(21) Appl. No.: 12/854,820

(22) Filed: Aug. 11, 2010

Related U.S. Application Data
(60) Provisional application No. 61/233,322, filed on Aug. 12, 2009.

(51) Int. Cl. G06F 3/01

(52) U.S. Cl. 715/716

(57) ABSTRACT

A system in accordance with the present invention may include one or more processors, memory from which the processor may fetch instructions according to a clock operating at a frequency, a display device, and one or more programs stored in the memory, with instructions to open a media file, play content of the media file, render graphically on the display device the played content of the media file, pause the played content of the media file, and render graphically on the display device options available during the pause.

This application claims the benefit and priority of U.S. provisional patent application No. 61/233,322, which was filed on Aug. 12, 2009, and is incorporated herein by reference in its entirety.

### FIELD OF INVENTION

The present invention relates generally to the field of media and, in particular, to a media interface with enhanced features such as, for example, providing options while the playing of a media file or media broadcast is paused.

### BACKGROUND OF INVENTION

Current media players may be used for playing live or pre-recorded content, which may be played by streaming the content over the Internet to a media player, or loading the content (e.g., source media file) from a local media storage device to a media player. Content may include audio, video, slideshow pictures, or any combinations thereof. Content may be represented according to one of many media file types (e.g., MP3, M3U, MPEG(-1, -2, -4), QuickTime Movie, AU, MIDI, JPEG, GIF, TIFF). Media players today also may offer features for controlling content, even during play. For example, media players today may offer features for playing content at a normal or accelerated speed, reverse playing content at a normal or accelerated speed, pausing the play of content, forwarding or reversing paused content, and skipping-over active content to new content.

However, current media players do not provide a feature for rendering graphically on a display device one or more options available on the media player after invoking a feature for pausing the playing of content. Moreover, current media players also do not provide a feature where the point in the media content at which the feature for pausing the playing of content is invoked is automatically saved as a favorite or pause point for at least the duration of the playing of the media content. In addition, the pause point may be noted by graphic rendering on the media player's navigation bar and may be readily accessible by invoking such features as, for example, a snap-back feature or a keyboard shortcut. Also, during the time in which the playing of content is paused, the media player interface may be graphically rendered to present one or more options that are media-related and access metadata, which may contain descriptive information that is graphically rendered on the media player in the form of text, audio, video, or a combination thereof. The media-related options may be graphically rendered, for example, between the media player's navigation bar and the media player's window for displaying the active playing content. Finally, the media player may further be graphically rendered, after invoking a feature for pausing the playing of content, to present the previous scene and next scene in windows to the left and right (i.e., on opposite sides) of the media player's window for displaying the active playing content, respectively. The next scene window may be blurred or otherwise graphically rendered as not viewable in order to not spoil the next scene to the user viewing the playing of the content; the user, however, may choose to override the blurring of the next scene and view the next scene's content.

### SUMMARY OF THE INVENTION

Accordingly, the present invention is directed to a system and method for playing, pausing, viewing, and controlling content that substantially obviates one or more problems due to limitations and disadvantages of the related art.

In an embodiment, the present invention provides a computer-implemented method for rendering graphics on a display device, the method including the steps of opening a media file or receiving a media broadcast, wherein the media file or media broadcast are stored locally or remotely, playing content of the media file or media broadcast at a default speed, rendering graphically on the display device the playing content of the media file or media broadcast, and rendering graphically on the display device options available after invoking a feature for pausing the playing content of the media file or media broadcast.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a system includes one or more processors, memory, a display device, and one or more programs stored in memory, where the one or more programs include instructions to open a media file or media broadcast, play content of the media file or media broadcast, render graphically on the display device the played content of the media file or media broadcast, pause the played content of the media file or media broadcast, and render graphically on the display device options available during the pause of the played content of the media file or media broadcast.

In an embodiment, a computer-readable storage medium stores one or more programs configured for execution by a computer, the one or more programs having instructions to open a media file or media broadcast, play content of the media file or media broadcast, render graphically on the display device the played content of the media file or media broadcast, pause the played content of the media file or media broadcast, and render graphically on the display device options available during the pause of the played content of the media file or media broadcast.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of the specification, illustrate embodiments of the invention and together with the description serve to explain the principles of the invention. In the drawings:

FIG. 1 is a block diagram illustrating an exemplary system in accordance with the present invention;

FIG. 2 illustrates an exemplary embodiment of a media player application graphically rendered after invoking a feature for pausing the playing of content in accordance with the present invention;

FIG. 2A illustrates an exemplary embodiment of a media player application graphically rendered with several invoked media-related options in accordance with the present invention;

FIG. 2B illustrates an exemplary embodiment of a media player application graphically rendered with text from invoked location and scene media-related options in accordance with the present invention;

FIG. 2C illustrates an exemplary embodiment of a media player application graphically rendered with pictures from invoked person and picture media-related options in accordance with the present invention;

FIG. 2D illustrates an exemplary embodiment of a media player application graphically rendered with audio/movie clip/information from invoked track and video media-related options in accordance with the present invention;

FIG. 2E illustrates an exemplary embodiment of a media player application graphically rendered with a search feature from an invoked search media-related option in accordance with the present invention;

FIG. 3 illustrates an exemplary embodiment of a media player application graphically rendered after invoking a snap-back or keyboard shortcut feature in accordance with the present invention;

FIG. 4 illustrates an exemplary system block diagram of a system executing a media player application in accordance with the present invention; and

FIG. 5 illustrates an exemplary module block diagram of the execution of the modules/engines of a media player application in accordance with the present invention; and

FIG. 6 illustrates exemplary method steps of a media application for rendering graphics on a display device in accordance with the present invention.

### DETAILED DESCRIPTION

Reference will now be made in detail to embodiments, examples of which are illustrated in the accompanying drawings. In the following detailed description, numerous non-limiting specific details are set forth in order to assist in understanding the subject matter presented herein. It will be apparent, however, to one of ordinary skill in the art that various alternatives may be used without departing from the scope of the present invention and the subject matter may be practiced without these specific details. For example, it will be apparent to one of ordinary skill in the art that the subject matter presented herein can be implemented on any type of standalone system or client-server compatible system containing any type of client, network, server, and database elements.

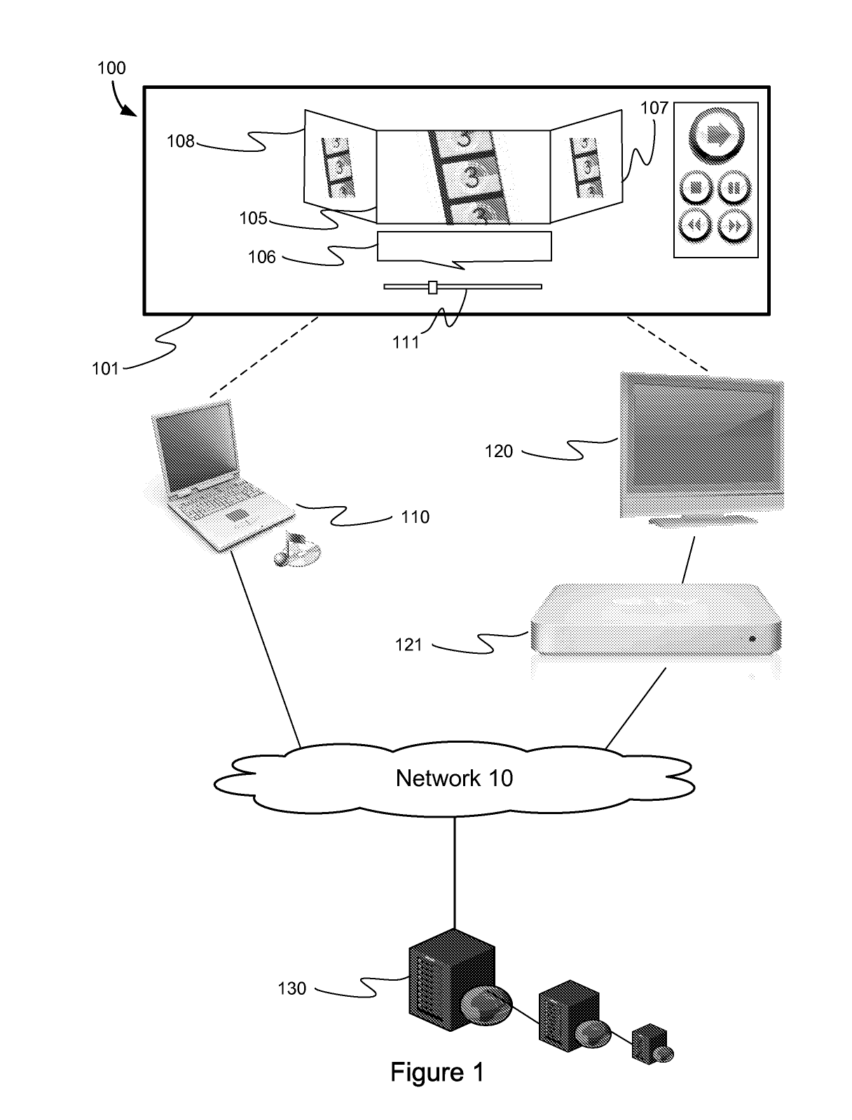

FIG. 1 is a block diagram illustrating an exemplary system 100 in accordance with the present invention. The exemplary system 100 comprises a computer 110 and/or a television or other display device 120 connected to a receiver or other media device 121, both of which may further be connected to a network 10 (e.g., Wide Area Network (WAN), Metropolitan Area Network (MAN), or Local Area Network (LAN)) over a wired (e.g., TCP/IP over Ethernet, IEEE 802.3) or wireless (e.g., WiFi (802.11), GSM, GPRS, W-CDMA, EDGE, or the like) communications protocol/layer. A handheld device (not shown) with a processor and memory may also be used in lieu of the computer 110. The handheld device may be configured for communication over the network 10. The network 10 may be connected to one or more servers 130 with access to one or more media storage devices (e.g., storage servers, databases, or the like). The servers 130 may receive requests over the network 10 to retrieve and transmit one or more media files/broadcasts that may contain media content (e.g., movies/videos, live/recorded television (TV) programming, pictures, music, or the like). Alternatively, the computers 110 and/or receivers or other media devices 121 may load media files/broadcasts locally from storage (e.g., hard drive, flash drive, CD-ROM/RW, tape drive, solid state memory, or the like), or via a connection to one or more other computers or servers (e.g., remotely).

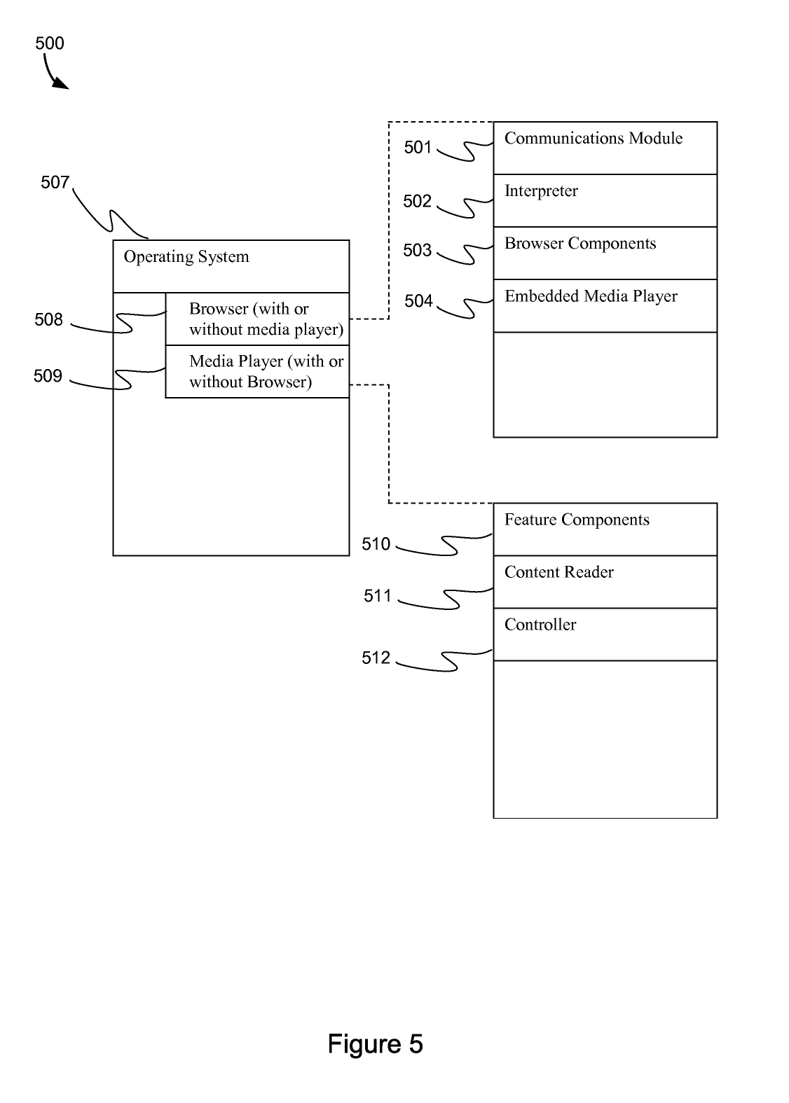

The active content window 105 of an exemplary media player application 101 may display the content of a media file/broadcast, with corresponding options that may be media-related options 106. The media player application 101 may be implemented by a media player module 509 (shown in FIG. 5) that executes on an operating system 507 (also shown in FIG. 5). The media player module 509 (or, a browser module 508 executing an embedded media player application 504) may call one or more graphics rendering modules via an application programming interface (API), or may implement the programming code (e.g., object-oriented event/exception-based code) necessary, for rendering the playing media content read from the media file/broadcast by the content reader module 511 (shown in FIG. 5) to the graphics card/output interface of the computer 110 and/or television or other display device 120.

In some embodiments, media files/broadcasts are loaded locally from storage or remotely and may subsequently be opened by the media player 101. The media player 101 may be a standalone program/application running on the computer 101 or the receiver or other media device 121. Alternatively, the media player 101 may be executed within a browser or other program and may access media files/broadcasts stored locally or remotely. The contents of a loaded media file/broadcast being played by the media player 101 may be displayed via the screen of the computer 110 or the TV 120 or other display device. The media player 101 may play the contents of the media file/broadcast in sequence order from the first frame to the last frame and the user/viewer may enjoy the current content being played in an active content window 105.

In some embodiments, the media player 101 may play the media file/broadcast contents at a default speed (e.g., at a specific frame(s)/second(s) rate), which may depend on the type of media file/broadcast and/or the media file's/broadcast's contents. In addition, before, during, or after playing the contents of a media file/broadcast, the control functions and features of the media player 101 may be used to accelerate the speed at which the content of an opened media file is played. The control functions and features of the media player 101 may further be used to pause the playing of media file content, skip-over content of the media file, reverse-play content of the media file, and/or recap earlier media content. The exemplary media player 101 also presents the played content in the active content window 105 and may display descriptive text (or other information in the form of an image, audio, video, or a combination of any of the foregoing) by invoking one or more media-related options 106. Descriptive information may also be displayed via a pop-up window or other graphical user interface component (GUI) without departing from the scope of the present invention.

The media-related options 106 available may be invoked through the media player application 101 and may call one or more modules of the media player module 509 or browser 508 such as, for example, the content reader module 511 or embedded media player module 504, respectively (shown in FIG. 5). Upon being invoked, these modules may access metadata that is associated with the media file/broadcast. The media-related options 106 may access metadata to identify and provide relevant biographical information about a person such as, for example, an actor(s) in a scene of a show, movie, picture, or other available media. Further, the media-related options 106 available may also be invoked to identify aspects of a specific scene such as, for example, where and/or when the scene was filmed, where and/or when the scene is being portrayed to take place, who directed and/or produced the scene, the current audio track associated with the scene, outtakes from the scene (e.g., “behind-the-scene” footage/film), and/or other related aspects of the scene. The mapping between the accessed metadata of the media file/broadcast and the specific information about a scene may be implemented through a file, or other data storage structure, that links the beginning and ending times of a scene or a unique scene identifier to the information relevant to that scene. The file, or other data storage structure, may be accessible by the content reader module 511 or embedded media player module 504 (shown in FIG. 5). Alternatively, the metadata may contain a mapping of available information for each scene, or other divider, of the media file/broadcast.

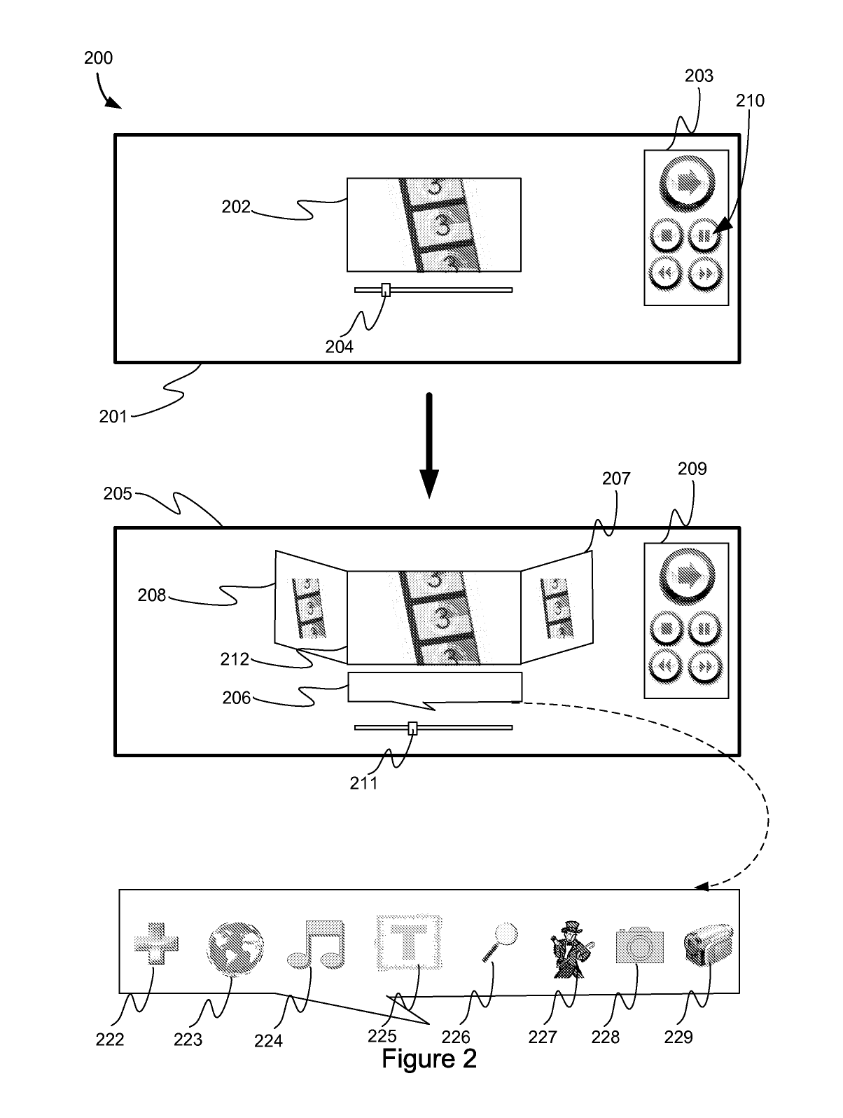

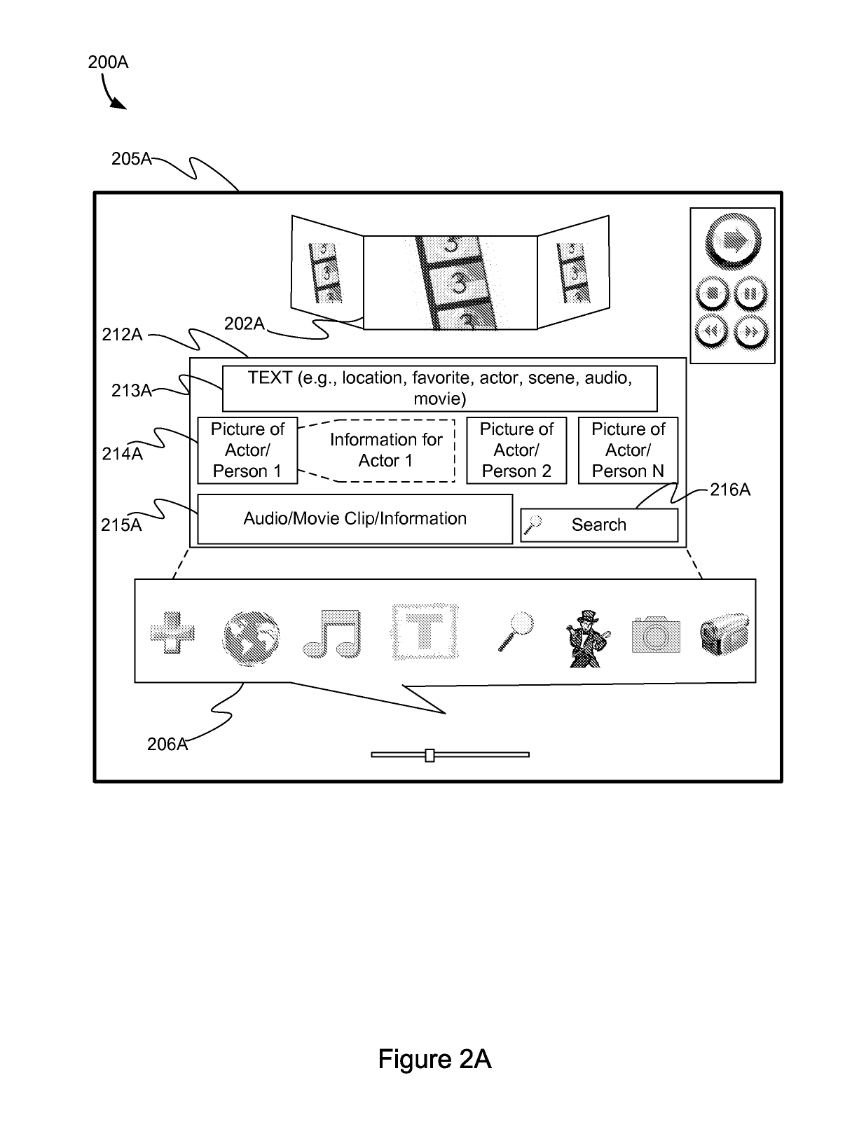

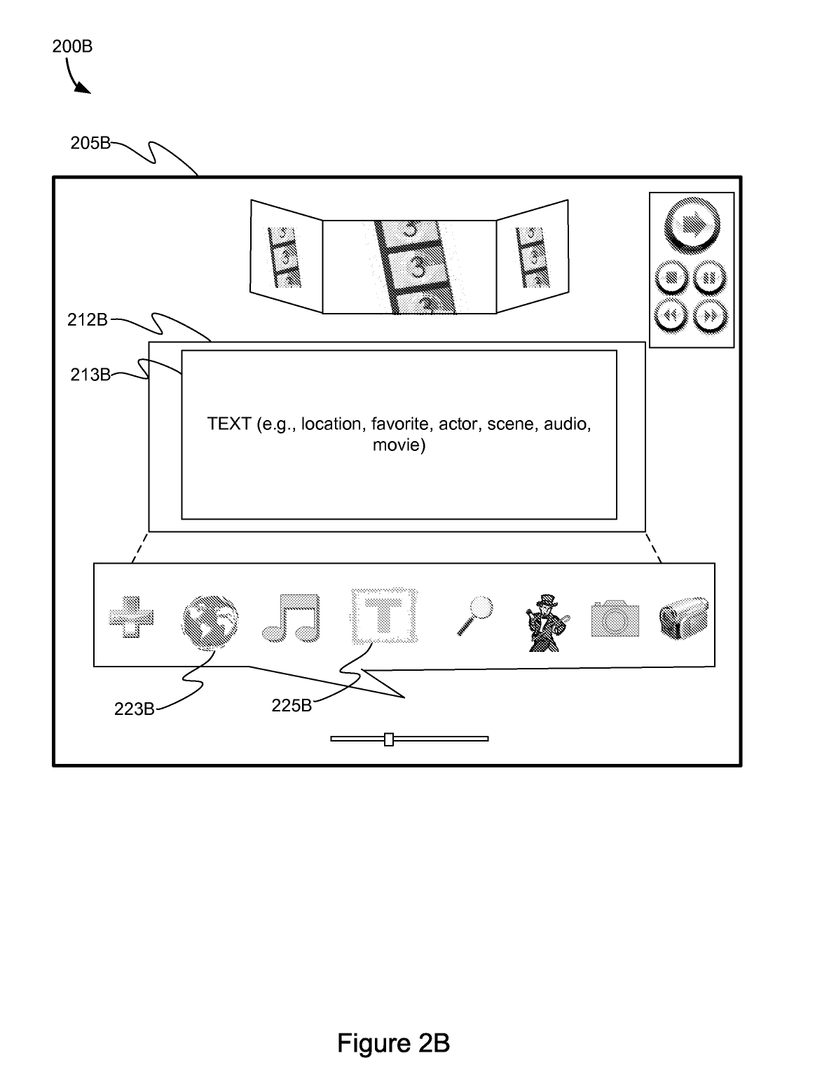

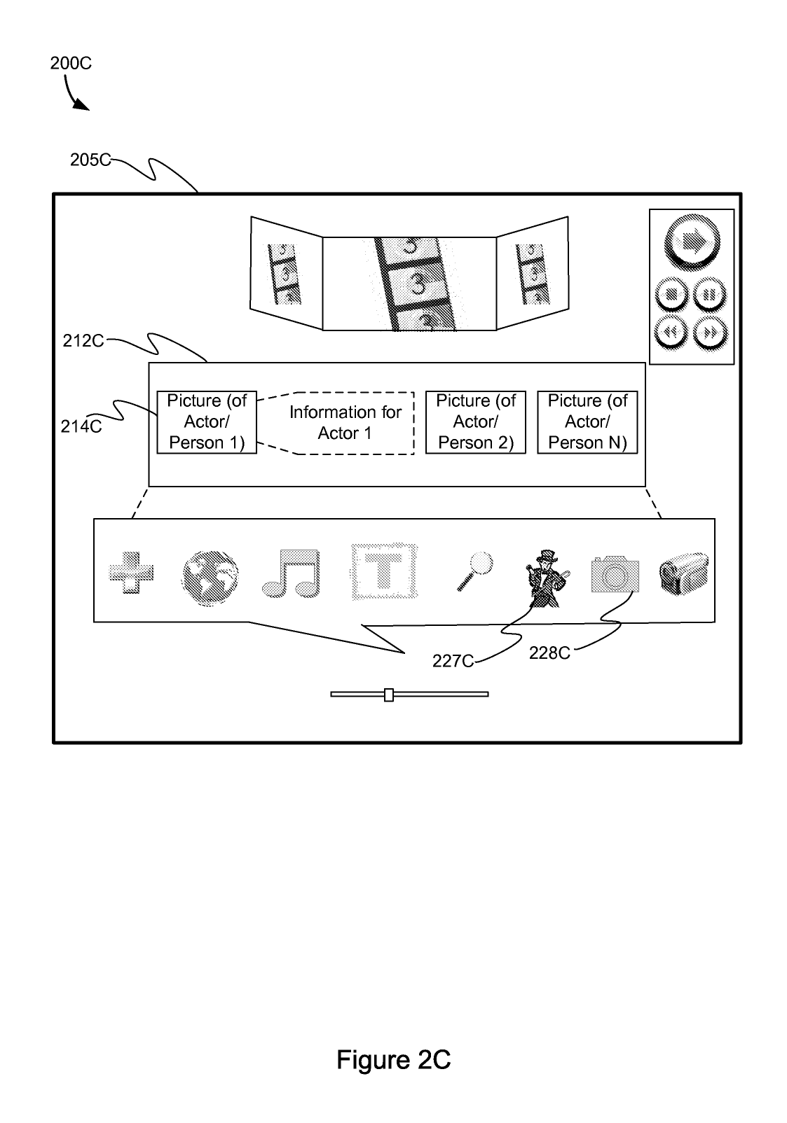

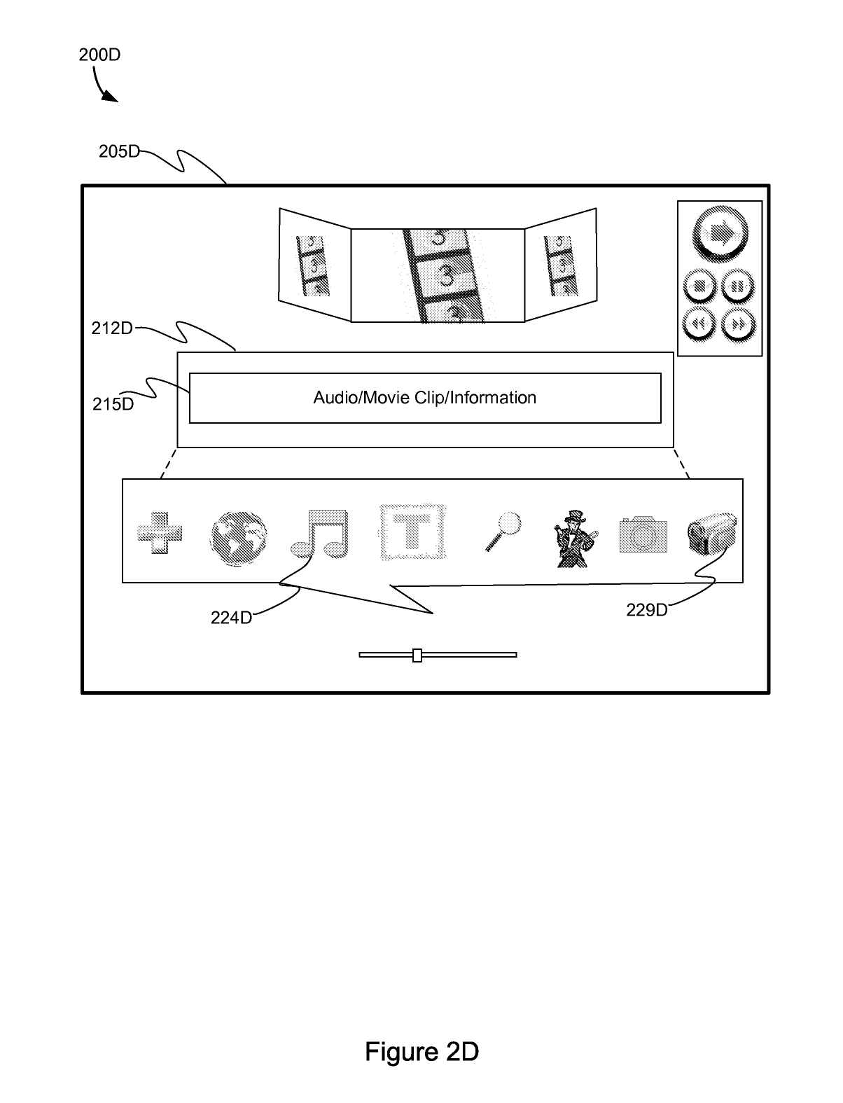

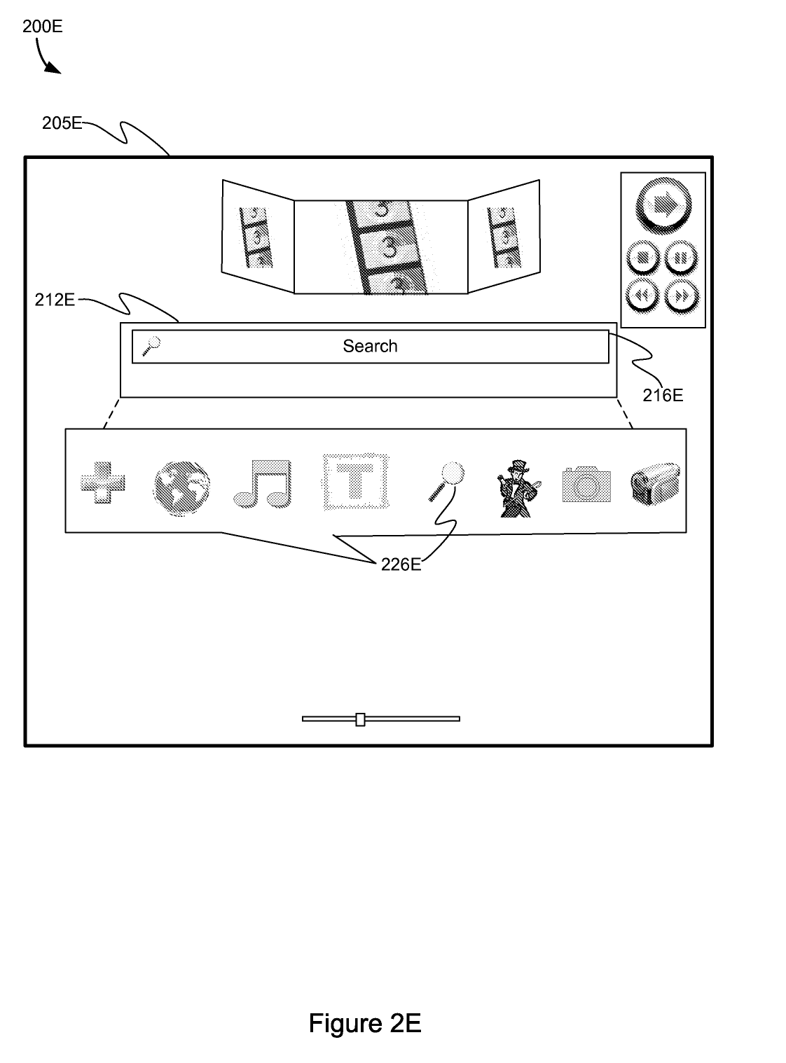

FIG. 2 illustrates an exemplary embodiment 200 of a media player application 205 graphically rendered after invoking a feature for pausing the playing of content in accordance with the present invention. An exemplary instance of the media player application 201 comprises an active content window 202, a navigation bar with progress tab 204, and a subset of media navigation features 203. The subset of media navigation features 203 includes a play button, a stop button, a pause button, a reverse play with acceleration (e.g., rewind)/snap-back to favorite pause point button, and a forward play with acceleration button (e.g., fast forward). Not all of these elements of the exemplary instance of the media player application 201 are necessarily required for its proper operation. Each of the media navigation features 203 may be implemented by the controller module 512 of the media player module 509, or the embedded media player module 504 of the browser 508 (shown in FIG. 5).

The exemplary instance of the media player user application 201 illustrates an active content window 202 presenting the played content of a media file/broadcast after invocation of one of the navigation features 203 such as, for example, the play button. The progress tab of the navigation bar 204 illustrates to the user viewing the played content in the active content window 202 the point at which the active scene being viewed lies in view of the non-played content, as well as the previously played content, of the same media file/broadcast. For example, the progress tab of the navigation bar 204 illustrates whether the active scene being viewed lies on or after one-third of content is played, or possibly lies on or after one-half of content is played, or at any other point on the navigation bar 204. Upon invoking the pause feature 210 of the subset of media navigation features 203, the media player application 201 is graphically rendered into a media player application 205 with a previous scene window 208, a next scene window 207, media-related options 206, a navigation bar 211, and navigation features 209. The media-related options 206 may be graphically rendered within the media player user interface 205 to be positioned underneath the active content window 212 and above the navigation bar 211. If the user then chooses to continue playing the content of the media file/broadcast, the media player user interface 205 may be graphically rendered such that the media-related options 206, the previous scene window 208, and the next scene window 207 are removed from view and the media player user interface 205 may appear as it previously did prior to invoking the pause feature 210 (e.g., media player application 201).

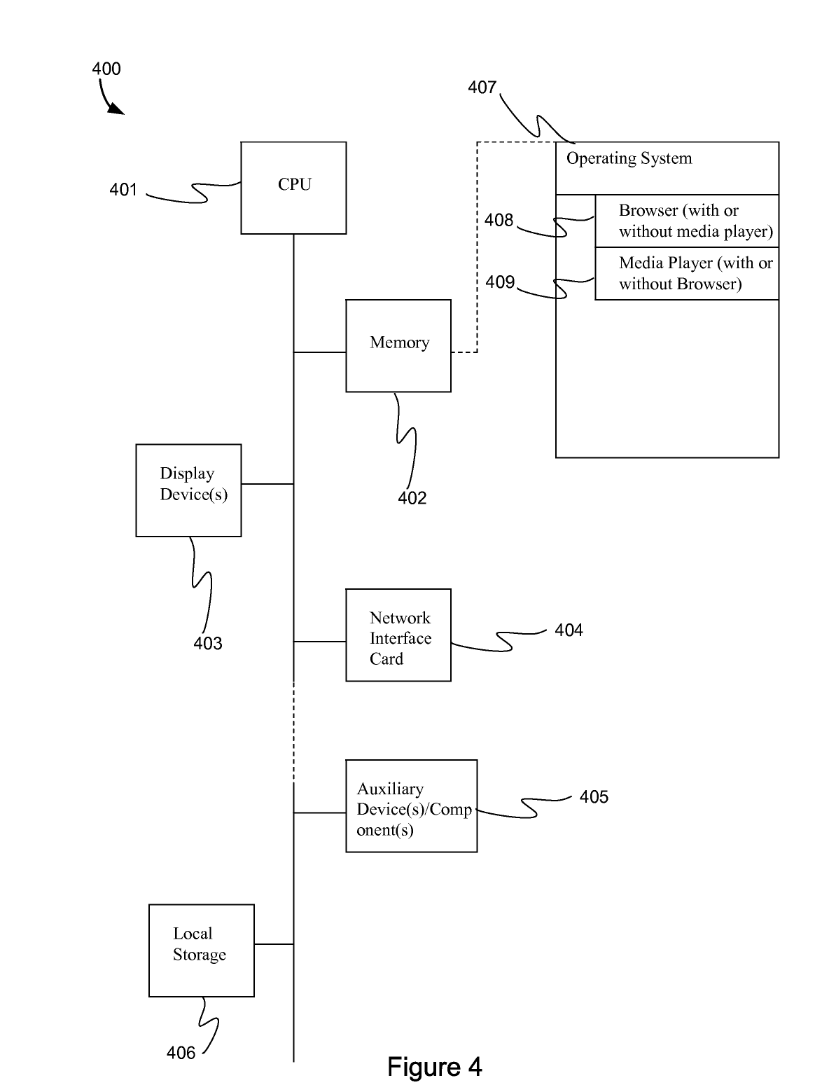

The media-related options 206 may identify whether a pause point in the playing content of the media file/broadcast is a favorite pause point, and provide an option for making the pause point a favorite 222. Identifying a pause point as a favorite may be done by placing an icon such as, for example, a plus sign (“+”), asterisk (“*”), a colored-dot, or other indicator on the navigation bar 211 at the point corresponding to where the favorite pause point lies. Also, the media-related options 206 may provide the capability for entering text or other data using a search feature 226 that may be implemented by a feature components module 510 of the media player module 509 (shown in FIG. 5). The search feature 226 may be used to search metadata associated with the content of the media file/broadcast. The metadata may be stored locally 406 (shown in FIG. 4) or remotely in a storage structure such as, for example, a file or database. The metadata may contain descriptive information, for example, regarding persons 227 (e.g., one or more actors), scenes 225 (e.g., with respect to the media file/broadcast setting), tracks 224 (e.g., audio track being played), locations 223 (e.g., geographic location on earth where the scene was filmed), pause points 222 (e.g., where the previous, current, and/or next favorite pause point is located in the media file/broadcast), and/or related information about the media file/broadcast such as, for example, pictures 228 (e.g., outtakes, scene-related pictures), video 229 (e.g., video outtakes, scene-related video clips), the length of play time (e.g., minutes, hours) and/or size of storage (e.g., MB/GB) of the media file/broadcast, the video/audio quality of the media file/broadcast, the source of the media file/broadcast (e.g., local or remote source/address/directory), and/or other relevant information (not shown).

The media-related options 206 may be invoked through a feature for pausing 210 the playing content of the media file/broadcast. The pausing feature 210 may be implemented by the controller module 512 (shown in FIG. 5), which may be called by the media player module 509 (or, alternatively, the embedded media player module 504). The previous scene window 208 may be on the left-hand side of the active content window 212 and the next scene window 207 may be on the right-hand side of the active content window 212; in some embodiments, the window arrangement may be reversed. The next scene window 212 may be blurred or otherwise graphically rendered as not viewable in order to not spoil the next scene to the user viewing the active playing content in the active content window 212; the user, however, may choose to override the blurring of the next scene window 212 and view the next scene's content. The user may override the blurring of the next scene window 212 by, for example, clicking a mouse pointer on the progress tab of the navigation bar 211 and continuing to drag the progress tab forward along the navigation bar, viewing in sequence the next scenes in the next scene window 207. Again, such control features may be implemented by the controller module 512 (shown in FIG. 5), which may be called by the media player module 509 (or, alternatively, the embedded media player module 504).

The media-related options 206, when invoked, may access metadata that may include descriptive information, which may be graphically rendered and presented on the computer 110 or other display device 120 outputting the graphics of the media player application 101 interface. The descriptive information may be graphically rendered to be presented in the form of text, audio, video, a picture/graphic, a caption, or a combination thereof according to the invoked media-related option.

FIG. 2A illustrates an exemplary embodiment 200A of a media player application 205A graphically rendered with several invoked media-related options 212A in accordance with the present invention. The media-related options 206A may be invoked by a user of the media player application 205A clicking on one of the graphics icons (or invoking another shortcut or keyboard/remote control button of the computer 110 or receiver or other media device 121). The invoked media-related options 212A may be presented as a pop-up window within the media player application 205A that may overlay one or more windows/components of the media player application 205A. Alternatively, the invoked media-related options 212A may be presented between the active content window 202A and the media-related options 206A. The movement of the media-related options 206A downwards and away from the active content window 202A may be shown to the user of the media player application 205A by continually refreshing the media player application 205A window for a distance the media-related options 206A is moved downwards and away from the active content window 202, which may be as long as or greater than the longitudinal height of the invoked media-related options 212A window being presented between.

In some embodiments, the invoked media-related options 212A may include text 213A information about the location of the scene in the active content window 202A, whether the scene is designated as a favorite, the actors in the scene, a summary of the scene, information about the audio track being played in the scene, and/or information about the movie.

In some embodiments, the invoked media-related options 212A may include a picture of the actors/persons in the scene 214A with associated text information about a picture that is invoked or highlighted within the invoked media-related options 212A window.

In some embodiments, the invoked media-related options 212A may include an audio and/or movie clip, and/or audio/movie clip information 215A. The audio/movie clip may be invoked to play an audio track/movie clip associated with the scene in the active content window 202A and/or may present text information regarding an audio track being played in the scene in the active content window 202A. A movie clip of outtakes related to the scene in the active content window 202A may also be played.

In some embodiments, the invoked media-related options 212A may include a search feature 216A, which may be used to search metadata associated with the content of the media file/broadcast.

FIG. 2B illustrates an exemplary embodiment 200B of a media player application 205B graphically rendered with text 213B from invoked location 223B and scene 225B media-related options 212B in accordance with the present invention.

FIG. 2C illustrates an exemplary embodiment 200C of a media player application 205C graphically rendered with pictures 214C from invoked person 227C and picture 228C media-related options 212C in accordance with the present invention.

FIG. 2D illustrates an exemplary embodiment 200D of a media player application 205D graphically rendered with audio/movie clip/information from invoked track 224D and video 229D media-related options 212D in accordance with the present invention.

FIG. 2E illustrates an exemplary embodiment 200E of a media player application 205E graphically rendered with a search feature 216E from an invoked search 226E media-related option 212E in accordance with the present invention. The search feature 216E may be implemented by a feature components module 510 of the media player module 509 (shown in FIG. 5). The search feature 216E may be used to search metadata associated with the content of the media file/broadcast.

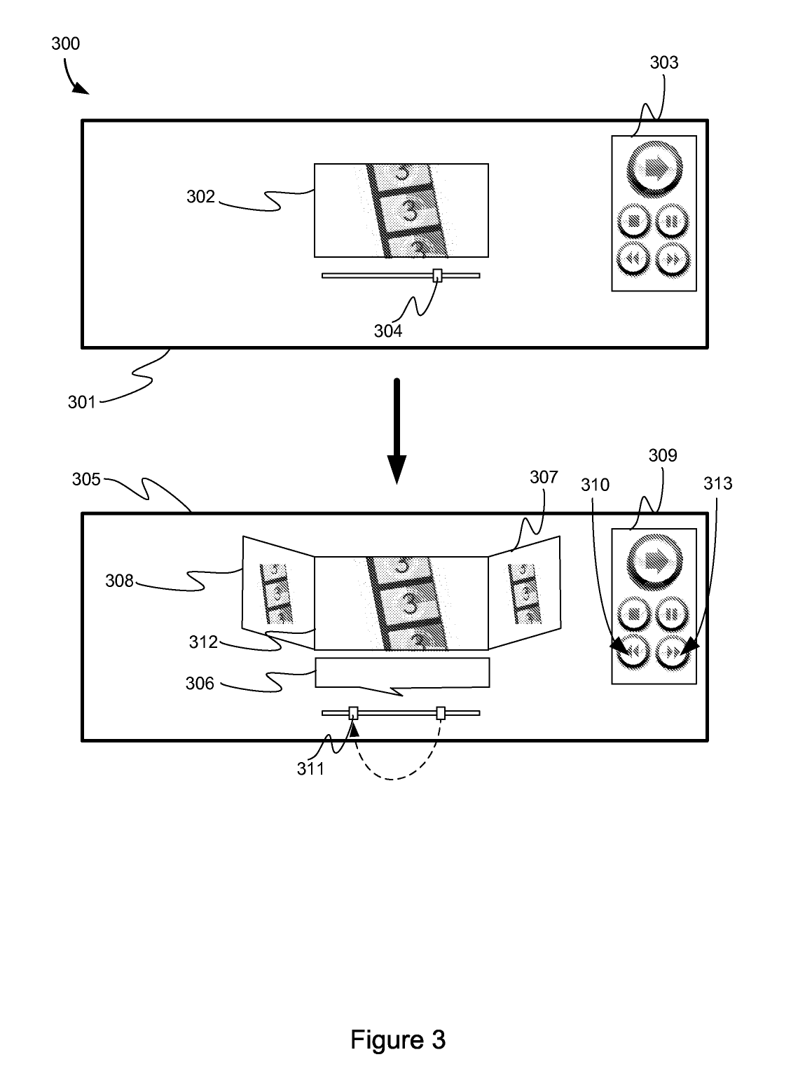

FIG. 3 illustrates an exemplary embodiment 300 of a media player application graphically rendered after invoking a snap-back or keyboard shortcut feature in accordance with the present invention. An exemplary instance of the media player application 301 comprises an active content 302 window, a subset of media navigation features 303, and a navigation bar with progress tab 304. Not all of these elements of the exemplary instance of the media player user interface 301 are necessarily required for its proper operation. Another exemplary instance of the media application 305 illustrates the state of the media application 305 after invoking a snap-back feature 310 of the subset of media navigation features 309. Upon invoking the snap-back feature 310 during the playing of a media file/broadcast, the controller module 512 (shown in FIG. 5) of the media player module 509 may access the metadata associated with the media file/broadcast and revert the progress tab of the navigation bar 311 back to the last favorite pause point that is available with respect to the current position of the progress tab of the navigation bar 311. Subsequent invocation of the snap-back feature 310 or a keyboard shortcut would continue to revert the progress tab of the navigation bar 311 back to the last favorite pause point that is available. If no favorite pause point is available with respect to the current position of the progress tab of the navigation bar 311, then invoking the snap-back feature 310 or a keyboard shortcut may revert the progress tab back to the beginning of the media file/broadcast. As the progress tab reverts back to the beginning of the media file/broadcast or the last favorite pause point, whichever is available, the active content window 312, the next scene window 307, and the previous scene window 308, as well the media-related options 306, may be updated to correspond to the point in the media file/broadcast where the progress tab of the navigation bar 311 now lies. In some embodiments, invoking a snap-forward or keyboard shortcut may cause the progress tab of the navigation bar 311 to snap-forward to the next favorite pause point that may be ahead of the current position of the progress tab. Once again, the active content window 312, the next scene window 307, and the previous scene window 308, as well the media-related options 306, may be updated to correspond to the point in the media file/broadcast where the progress tab of the navigation bar 311 now lies.

FIG. 4 illustrates an exemplary system block diagram of a system executing a media player application in accordance with the present invention. The exemplary system 400 for implementing an exemplary embodiment of the present invention comprises a computer processing unit (CPU) 401, memory 402, display device(s) 403, a network interface card (NIC) 404, auxiliary device(s)/component(s) 405, and local storage 406. These elements may communicate over one or more local buses. The CPU 401 may fetch instructions to execute from memory 402, where the instructions may be from an operating system 407 and, further, from a browser 408 (with or without having an embedded media player) and/or media player 409 (with or without being embedded in a browser) executing via the operating system 407. The media player 409 may receive/fetch media files from local storage 406 and/or over a network 10 using the NIC 404 for communication with one or more servers 1030. The media player 409 may also be embedded within a browser 408 and may access media files in local storage 406 and/or over a network 10. The display device(s) 403 may be a laptop or computer display, TV screen, or other display (e.g., such as that of a handheld device) capable of receiving display signals. The display signals may comprise, for example, one or more frames per second of video or other media content. The media content may be opened and played by the media player 409. Other auxiliary device(s)/component(s) 405 may also receive or otherwise communicate via the local bus. For example, a portable media player, mobile telephone, or other auxiliary device may act as a source/sink of media files. The auxiliary device(s)/component(s) 405 may also be additional display devices and/or media devices capable of supporting the execution of the media player.

FIG. 5 illustrates an exemplary module block diagram of the execution of the modules/engines of a media player application in accordance with the present invention. The exemplary modules 500 for implementing an exemplary embodiment of the present invention comprise browser modules 501-504 and/or media player modules 510-512. The browser modules 501-504 may comprise a communications module 501, an interpreter 502 (e.g., XML, HTML or script/mark-up language interpreter), browser components 503 (e.g., navigation functions, add-in(s)/on(s), custom user options), and an embedded media player 504. The media player modules 510-512 may comprise feature components 510, a content reader 511, and a controller 512. The browser modules may be used to implement the browser-related features of the exemplary embodiments, while the media player modules may be used to implement the media player-related features of the exemplary embodiments.

In some embodiments, the communications module 501 receives and transmits data over a network (e.g., network 10) through one or more ports (e.g., HTTP port 80); the interpreter 502 may interpret scripts/mark-up languages and execute them in accordance with their instructions; the browser components 503 may implement features such as those for navigating the Internet, supporting add-in(s)/on(s), implementing custom user options and executing in accordance with those options (e.g., permissions, home page preference, bookmarks, script preferences, history preferences, privacy preferences, web page preferences, and/or other Internet/user options); and, the embedded media player 504 (which may, in some embodiments, be an add-in/on) may play media content in accordance with the present invention as described herein.

In some embodiments, the feature components 510 may implement features such as media playlist management, media type conversion, media compression/decompression, media playlist/library synchronization, media ripping/burning from/to external storage mediums, media player options (e.g., window size, volume, media quality, play speed); the content reader 511 may read and decode the contents of a media file, where the media file contents may be represented according to a specific file type and compressed; and, the controller 512 may implement features for opening, navigating, controlling access to, and/or manipulating media files and/or their content.

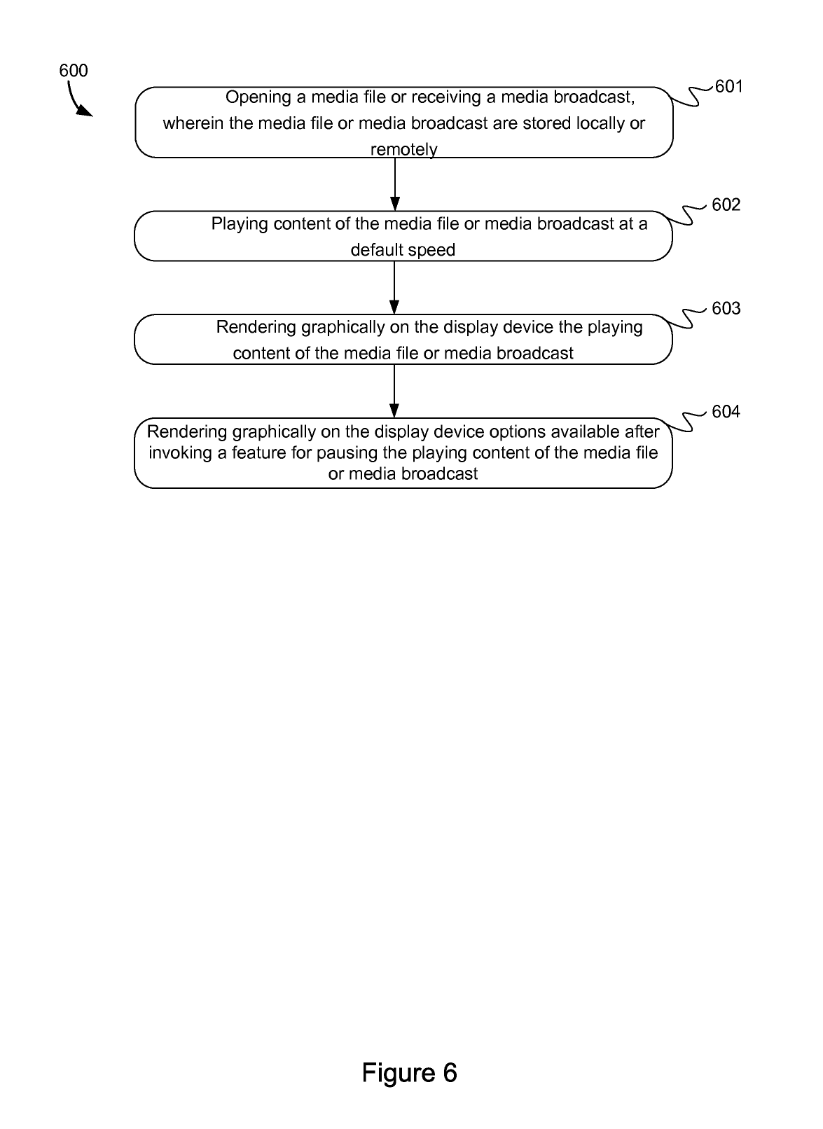

FIG. 6 illustrates exemplary method steps 600 of a media application for rendering graphics on a display device in accordance with the present invention. The computer-implemented methods steps are for opening a media file or receiving a media broadcast, wherein the media file or media broadcast are stored locally or remotely 601, playing content of the media file or media broadcast at a default speed 602, rendering graphically on the display device the playing content of the media file or media broadcast 603, and rendering graphically on the display device options available after invoking a feature for pausing the playing content of the media file or media broadcast 604.

It will be apparent to those skilled in the art that various modifications and variations can be made to the present invention without departing from the spirit or scope of the invention. Thus, it is intended that the present invention cover the modifications and variations of this invention provided they come within the scope of the appended claims and their equivalents.

We claim:

1. A computer-implemented method for rendering graphics on a display device, comprising:
opening a media file or receiving a media broadcast, wherein the media file or media broadcast are stored locally or remotely;
playing content of the media file or media broadcast at a default speed;
rendering graphically on the display device the playing content of the media file or media broadcast; and
rendering graphically on the display device options available after invoking a feature for pausing the playing content of the media file or media broadcast.

2. The computer-implemented method of claim 1, wherein the options comprise media-related options.

3. The computer-implemented method of claim 2, wherein the media-related options comprise identifying a person, identifying a scene, identifying a track, identifying a location, adding a favorite pause point, and searching the media file.

4. The computer-implemented method of claim 2, wherein the media-related options access metadata.

5. The computer-implemented method of claim 4, wherein the metadata comprises descriptive information, the descriptive information being rendered graphically on the display device as text, audio, video, a picture/graphic, a caption, or a combination thereof.

6. The computer-implemented method of claim 5, wherein the descriptive information comprises person information, scene information, track information, location information, pause point information, and media file information.

7. The computer-implemented method of claim 1, further comprising the step of associating a pause point with the media file or media broadcast after invoking the feature for pausing the playing content of the media file or media broadcast.

8. The computer-implemented method of claim 7, wherein the pause point is noted by graphic rendering on a media navigation bar.

9. The computer-implemented method of claim 8, wherein the media navigation bar comprises a snap-back feature for returning to the pause point.

10. The computer-implemented method of claim 8, wherein a snap-back feature is invoked via a keyboard shortcut.

11. The computer-implemented method of claim 1, further comprising the step of rendering graphically on the display device a previous scene after invoking the feature for pausing the playing content of the media file or media broadcast.

12. The computer-implemented method of claim 1, further comprising the step of rendering graphically on the display device a next scene after invoking the feature for pausing the playing content of the media file or media broadcast.

13. The computer-implemented method of claim 1, further comprising the step of rendering graphically on the display device a previous scene window and a next scene window on opposite sides of an active content window after invoking the feature for pausing the playing content of the media file or media broadcast.

14. A system, comprising:
one or more processors;
memory;
a display device;
one or more programs stored in memory, the one or more programs comprising instructions to:
open a media file or media broadcast;
play content of the media file or media broadcast;
render graphically on the display device the played content of the media file or media broadcast;
pause the played content of the media file or media broadcast; and
render graphically on the display device options available during the pause of the played content of the media file or media broadcast.

15. The system of claim 14, wherein the options comprise media-related options.

16. The system of claim 15, wherein the media-related options comprise identifying a person, identifying a scene, identifying a track, identifying a location, adding a favorite pause point, and searching the media file.

17. The system of claim 15, wherein the media-related options access metadata.

18. The system of claim 17, wherein the metadata comprises descriptive information, the descriptive information being rendered graphically on the display device as text, audio, video, a picture/graphic, a caption, or a combination thereof.

19. The system of claim 18, wherein the descriptive information comprises person information, scene information, track information, location information, pause point information, and media file information.

20. The system of claim 14, further comprising the step of associating a pause point with the media file or media broadcast after invoking the feature for pausing the playing content of the media file or media broadcast.

21. The system of claim 20, wherein the pause point is noted by graphic rendering on a media navigation bar.

22. The system of claim 21, wherein the media navigation bar comprises a snap-back feature for returning to the pause point.

23. The system of claim 14, further comprising the instruction to render graphically on the display device a previous scene during the pause of the played content of the media file or media broadcast.

24. The system of claim 14, further comprising the instruction to render graphically on the display device a next scene during the pause of the played content of the media file or media broadcast.

25. The system of claim 14, further comprising the instruction to render graphically on the display device a previous scene window and a next scene window on opposite sides of an active content window during the pause of the played content of the media file or media broadcast.

26. A computer-readable storage medium storing one or more programs configured for execution by a computer, the one or more programs comprising instructions to:
open a media file or media broadcast;
play content of the media file or media broadcast;
render graphically on the display device the played content of the media file or media broadcast;
pause the played content of the media file or media broadcast; and
render graphically on the display device options available during the pause of the played content of the media file or media broadcast.
